(19) United States
(12) Patent Application Publication
(10) Pub. No.: US 2007/0050630 A1
(43) Pub. Date: Mar. 1, 2007

(54) Authentication method and system for asynchronous eventing over the internet

(75) Inventors: Praveen Kumar, San Jose, CA (US); Yu Song, Milpitas, CA (US); Alan Messer, Los Gatos, CA (US); Doreen Cheng, San Jose, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/354,405

(22) Filed: Feb. 14, 2006

Related U.S. Application Data
(60) Provisional application No. 60/711,096, filed on Aug. 24, 2005.

(51) Int. Cl. H04L 9/00

(52) U.S. Cl. 713/182

(57) ABSTRACT

An authentication method and system is provided for asynchronous eventing between a client and a server over the Internet. In a subscription phase, the client sends a subscription request to the server to express interest in receiving notifications associated with one or more particular events that may asynchronously occur on the server. The client authenticates the server by checking the identity of the server, and if the client determines that the server can be trusted, the client subscribes the notifications, otherwise, the client does not subscribe. After a successful subscription, in a notification phase, the server notifies each client that has subscribed for a particular type of event. Each client upon receiving a notification, authenticates the server by verifying that the received notification is sent by the server with which the client subscribed for the notification.

### RELATED APPLICATION

Priority is claimed from U.S. provisional patent application Ser. No. 60/711,096 filed on Aug. 24, 2005, which is incorporated herein by reference.

### FIELD OF THE INVENTION

The present invention relates generally to asynchronous eventing and in particular to authentication method and system for asynchronous eventing.

### BACKGROUND OF THE INVENTION

A rich body of security schemes for authentication has been developed since commercial computers and networks came to existence. The pervasive use of the Internet has made the security issue critically important and urgent. As a result, standardization bodies have integrated many of these schemes into communication protocols at various network layers. SSL and HTTPS are two most widely used examples.

While Internet e-commerce applications, such as online banking and shopping, have been using security schemes and protocols for years, the need for security for applications running on home digital CE (consumer electronic) devices are just becoming clear. Consequently, the prior art does not provide for secure Internet eventing that involves CE devices.

The most widely used applications such as email and Web browsing have long had built-in security measures. The following is a list of them:
1. Secured POP uses user supplied user name and password for authentication.
2. Secured SMTP uses user supplied user name and password for authentication.
3. In PGP and S/MIME, authentication is accomplished through the use of message signing. Specifically, a sender signs a message using its private key and a receiver verifies the signature using the sender's public key, where the keys are issued by a trusted certification authority.
4. SSL is a socket layer protocol that requires server verification when a connection is to be established
5. HTTPS is an application level protocol that uses SSL for secure communication.
6. HTTP Authentication is an authentication specification.

However, the disadvantages of such existing email security measures are:
1. Email is a public system. The email server on the receiving side can be different from the email server on the sending side. To secure the email, both receiving and sending email servers must employ security measures; otherwise, the email will not get delivered, or delivered without security check. Requiring secure emailing over the Internet requires every email server on the Internet to change their security infrastructure, which is not likely to happen in a short period of time.
2. Standards, such as PGP (Pretty Good Privacy) and S/MIME (Secure/Multipurpose Internet Mail Extensions) are not compatible with each other. As a result, sending email with PGP, will not be checked by receiver side that employs S/MIME. This means that secure emailing over the Internet further requires either all email servers to use a same standard or the use of bridging software between non-compatible standards, which may push its realization into more remote future.

The disadvantage of the secure Internet communication protocols are:
1. Both HTTP and SSL requires public key infrastructure (PKI). To authenticate a sender via the PKI, the sender must obtain a certification from a certificate authority. Requiring every device to obtain a certificate adds significant cost to the devices, which will certainly delay the acceptance from CE device manufacturers.
2. HTTP Authentication method provides a scheme for client (e.g., browser) authentication. However, the specification does not specify how secrets are distributed among devices. Since secret distribution is a well known difficult problem, it is uncertain how this scheme will work out.

### BRIEF SUMMARY OF THE INVENTION

In one embodiment the present invention provides an authentication method and system for asynchronous eventing over the Internet. In one implementation, an authentication method and system is provided for asynchronous eventing between a client and a server over the Internet. In a subscription phase, the client sends a subscription request to the server to express interest in receiving notifications associated with one or more particular events that may asynchronously occur on the server. The client authenticates the server by checking the identity of the server, and if the client determines that the server can be trusted (e.g., will not send spam), the client requests for notification subscription, otherwise, the client will not subscribe. After a successful subscription, in a notification phase, the server notifies each client that has subscribed for a particular type of event. Each client upon receiving a notification, authenticates the server by verifying that the received notification is sent by the server with which the client subscribed for the notification.

This system and method enhances security in Internet eventing that involves CE devices. Compared with prior art, authentication schemes according to the present invention are suited to CE devices that require low cost, that can be behind firewalls, and that can roam from one location to another possibly cross network domains. Further, the authentication schemes according to the present invention do not require key distributions among CE devices. Since securely distributing keys is a difficult problem, the present invention provides high security for eventing over the Internet. Further, the authentication schemes according to the present invention do not require communicating CE devices to have certificates. Since requiring all communicating CE devices to have their own certificates will at least slow down the acceptance by device manufacturers as well as consumers, the present invention has is more desirable the marketing place.

These and other features, aspects and advantages of the present invention will become understood with reference to the following description, appended claims and accompanying figures.

### BRIEF DESCRIPTION OF THE DRAWINGS

FIG. 1 shows an example system implementing a handshaking authentication protocol (Scheme 1, Embodiment 1) according to an embodiment of the present invention.

FIG. 2 shows another example system implementing a handshaking authentication protocol (Scheme 1, Embodiment 2) according to an embodiment of the present invention.

FIG. 3 shows another example system implementing a handshaking authentication protocol (Scheme 2, Embodiment 1) according to an embodiment of the present invention.

FIG. 4 shows another example system implementing a handshaking authentication protocol (Scheme 2, Embodiment 2) according to an embodiment of the present invention.

FIG. 5 shows another example system implementing a handshaking authentication protocol (Scheme 3) according to an embodiment of the present invention.

FIG. 6 shows another example system implementing a handshaking authentication protocol (Scheme 4) according to an embodiment of the present invention.

FIG. 7 shows another example system implementing a handshaking authentication protocol (Scheme 5) according to an embodiment of the present invention.

### DETAILED DESCRIPTION OF THE INVENTION

Almost all smart-home applications in the areas of sharing digital assets among relatives and friends, and monitoring and/or controlling home CE devices for home security, entertainment, automation, and healthcare, depend on the devices being able to send/receive asynchronous events (also known as eventing) to/from each other, and/or to/from other digital devices such as servers of an ISP (Internet Service Provider) or ASP (Application Service Provider). In other words, eventing is a core communication mechanism of these applications; therefore, it is critical to make the eventing as secure as possible over the Internet. Enabling CE device to communicate events securely through the Internet is an object of the present invention.

It is now well known that using Internet applications, such as email and Web browsers, poses severe security risks. In its least harmful form, a user's mail box may be filled with a large quantity of uninvited and unwanted emails (spam). In more severe cases, malicious software sneaked into a user's system through security holes may intentionally damage the system, steal user's identity and confidential information, and/or use the system to launch attacks with the intention to bring down critical systems in an attempt to raise fear and disturb peace in the society.

With smart home applications proliferating, an almost infinitude digital consumer electronic (CE) devices mobile as well as fix-positioned, may possess the capability of communicating with any digital devices through the Internet. Consequently, the above problems will be magnified by a multitude of factors. In addition to the enormously increased number of platforms from which a malicious hacker can launch security attacks and bring down critical systems at an increased rate, uninvited and unwanted digital content, such as messages and advertisement, frequently pops up in the middle of a movie can make consumers reject the applications and the CE devices all together. In other words, without security measures built into the communication framework, the applications and networked digital CE devices are unlikely to be accepted by the consumers, let alone it may invite regulations from the government.

Secure communication usually includes authentication, authorization, and message integrity. The key to making eventing secure among digital devices through the Internet is to provide a mechanism for the communicating parties to verify each other's true identity. The applications and/or the communication system software can then choose to block suspicious communication attempts. Authentication, as the result of decades of research and development in the security business, is specifically designed for this purpose.

In one embodiment, the present invention devises authentication schemes for secure event communication that involves CE devices over the Internet. As such, the present invention provides a method and system that enables secure communication of events between CE devices and between CE devices and other electronic devices via the Internet, so as to reduce possibilities for spam and/or malicious attacks. Commonly assigned patent application titled “Methods and systems for asynchronous eventing over the Internet”, attorney docket SAM2A.PAU.22 (incorporated herein by reference), describes schemes that enable CE devices to communicate events at low costs over the Internet and through firewalls. The present invention devises schemes that ensure secure communication. For simplicity, the same basic framework of eventing as said commonly assigned patent application is used, and further the same terminology is used, as follows. Eventing in the simplest case involves a source which generates events and a client which wants to be informed when the events occur. In the context of this description, source, server and publisher are interchangeably used to denote a source device/application; client, destination and subscriber are used interchangeably to denote a client device/application, and notification represents a message sent to notify a client about the occurrence of an event.

Authentication Schemes

The key to making eventing secure among digital devices through the Internet is to provide a mechanism for the communicating parties to verify each other's true identity, according to the present invention. The applications and/or the communication system software can then choose to block suspicious communication attempts. This description provides five example authentication schemes for secure event communication (secure notification schemes) that involves CE devices over the Internet, according to the present invention. These example schemes assume that: (1) all routers including core and edge routers in the Internet are trusted, (2) certifications issued by a legal certification authority are trusted, and (3) security attacks that require physically removing one device from a secure local area network (LAN) and replacing the device by a malicious device are difficult and occur very rarely and therefore not attempt to prevent it.

Each of the above-mentioned secure notification schemes are performed in two disjoint phases: a subscription phase and a notification phase. In a subscription phase a client, e.g. an application running on a home device, sends a subscription request to a server, e.g. an ISP server or another device at home, in an attempt to express its interest in receiving notifications associated with some events that may asynchronously occur on the server. The client checks the identity of the server and if the client determines that the server can be trusted (e.g. the server will not send spam), the client will subscribe; otherwise, the client will not subscribe. Additional information may be passed in the subscription phase in order to identify the event type and the subscriber. In the notification phase, the server sends a notification to each and every client that has subscribed for notifications about the event occurrences. During the notification phase, each client must verify that the notification arrived is in fact sent by the server with which it subscribed for the notification at an earlier time.

The five secure notification schemes use different protocols for the security handshaking during the above two phases. For clarity, the simplest embodiments are used to explain the schemes. However, as those skilled in the art will recognize, the present invention is applicable also to any cases that involve more than one instance of any of the participating parties including clients, servers, homes, devices, gateways, etc.

In the following description, two types of communication links are used in the context of secure Internet eventing: Source Authenticate-able Links (SAL) and InSecure Links (ISL). A SAL is a link through which communicating parties can securely verify the identity of each other, whereas an ISL is a link that does not provide any security measures. Examples of SAL include SSL and HTTPS, and examples of insecure links include email, HTTP, TCP/UDP. In the following SAL and ISL are used to indicate the type of links used in each particular scheme.

### Scheme 1

This scheme uses SAL for subscription and ISL for sending notifications. The scheme uses the domain name included in an HTTPS URL link embedded in a notification email from a notification sender to a notification receiver to verify the identity of the sender of a notification. Two example embodiments of this scheme are now described.

### Scheme 1, Embodiment 1

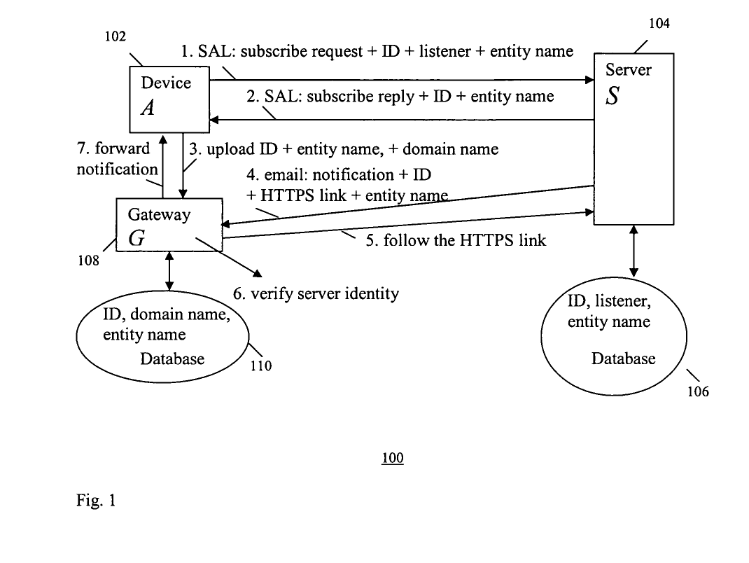

As shown by example system 100 in FIG. 1, in the simplest case, this embodiment involves a home with a device A (102), a home gateway G (108) which serves Device A, and a server S (104) which may be remotely linked through the Internet. This example secure notification method includes the following steps 1-7 shown in FIG. 1:
Step 1: Device A uses a SAL to send a request to subscribe a service from Server S on the Internet. Included in the request, Device A also sends a request ID, an entity name, and listener information. The request ID identifies the requested event type, the entity name identifies the device or an application running on the device A, and the listener information tells the server where to send notifications. An example of the request ID is an integer and an example of listener information is the email address of the home gateway G. The entity name can either be generated by a machine or provided by a user. Before establishing a connection to the server S, the server's identity is verified in the SAL.
Step 2: Server S sends a subscription reply to Device A indicating whether the subscription process is successful in the same SAL. The reply also includes the ID and the entity name. If the subscription process succeeds, the server S also stores the ID, the entity name, and the listener in a data storage indicated as the database 106 linked to it if any of them are not there.
Step 3: Upon receiving a failed subscription reply, Device A may choose to log the information, prompt user actions, or retry the subscription. If the reply indicates a successful subscription, Device A uploads the request ID, the entity name, and the domain name of the server S to Gateway G. The domain name is known to the device A since it initiated the subscription process. The gateway G then records the information in a data storage which is indicated as the database 110 linked to it.
Step 4: At a later time, when an event corresponding to the request ID occurs on Server S, for each and every listener that has successfully subscribed to the event, the server S sends an email using the email address for the listener (e.g. Gateway G, etc.). In the email, the server S includes the request ID, the entity name, and an HTTPS URL link pointing to the Web page that contains the notification.
Step 5: Upon receiving the email, Gateway G follows the HTTPS link to fetch the notification.
Step 6: Upon receiving the notification, the gateway G extracts the domain name from the certificate and the domain name stored in its database 110 indexed by the ID and the entity name. Gateway G then compares the two. If they are identical, proceed to Step 7. Otherwise, gateway G discards the notification.
Step 7: The gateway G forwards the notification to Device A according to the entity name and the device processes the notification.

A first variation of this embodiment is to replace the email-based notification used above with an HTTP-based notification.

A second variation of this embodiment is to replace the push-based notification used above with a polling-based notification. Specifically, in Step 3 above Device A also starts polling for notification, and Step 7 is to be eliminated.

### Scheme 1, Embodiment 2

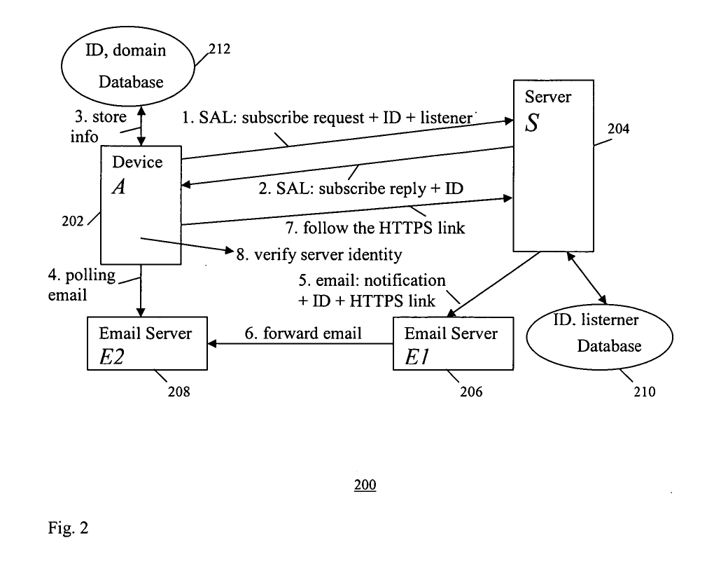

As shown by the example system 200 in FIG. 2, in the simplest case, this embodiment involves a home with a device A (202), a server S (204) which may be remotely linked through the Internet, a first email server E1 (206) which may be linked to Server S via either a LAN or the Internet, and a second email server E2 (208) which may be linked to Device A via either a LAN or the Internet. Either or both of the email servers E1, E2 can belong to any service providers or enterprise or home. This embodiment includes the following steps 1-8 shown in FIG. 2:
Step 1: Device A uses a SAL to send a request to subscribe a service from Server S on the Internet. Included in the request, the device A also sends a request ID and listener information. The request ID identifies the requested event type and the listener information tells the server S where to send notifications. An example of the request ID is an integer, and an example of listener information is the email address of Device A whose email is served by the email server E2. Before establishing a connection to the server S, the server's identity is verified using the SAL.
Step 2: Server S sends a subscription reply to Device A to indicate whether the subscription is successful in the same SAL. If it is, the server stores the ID and listener in a data storage indicated as the database 210 linked to it if any of them are not yet there.
Step 3: Upon receiving a failed reply, Device A may choose to log the information, prompt user actions, or retry the subscription. If the reply indicates a successful subscription, Device A stores the request ID and the domain name of the server S in a data storage which is indicated as the database 212 linked to it.
Step 4: Device A starts to poll for email from the email server E2, if it has not done so already.
Step 5: At a later time, when an event corresponding to the request ID occurs on Server S, for each and every listener that has successfully subscribed to the event, the server S sends an email using the email address for the listener. In the email, the server S includes the request ID and an HTTPS URL link pointing to the Web page that contains the notification.
Step 6: The email server E1 forwards the email to the email server E2, possibly through zero or more routers in the Internet.
Step 7: Upon receiving the email through polling in Step 4, Device A follows the HTTPS link to fetch the notification.
Step 8: Upon receiving the notification, Device A extracts the domain name from the certificate and compares the domain name with the domain name previously stored in the database indexed by the request ID. If they are identical, the device A processes the notification. Otherwise, it discards the notification.

### Scheme 2

This scheme uses a SAL for both authentication and notification. The identity of the sender of the notification is verified using the SAL protocol stack. Below two example embodiments of this scheme are described.

### Scheme 2, Embodiment 1

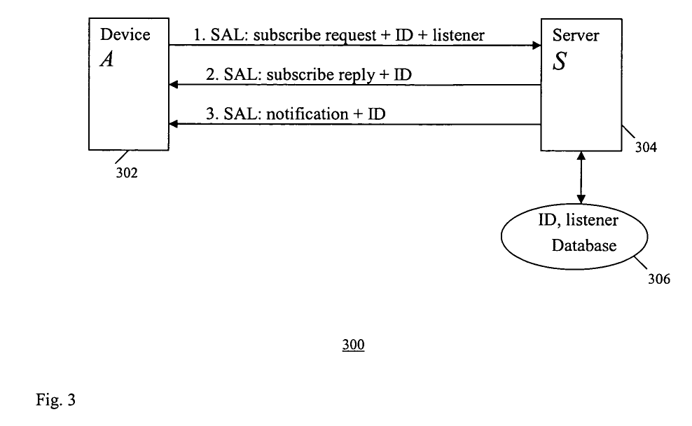

As shown by example system 300 in FIG. 3, in the simplest case, this scheme involves a device A (302) and a server S (304) which may be remotely linked through the Internet. This scheme includes the following steps 1-3 shown in FIG. 3:
Step 1: Device A uses a SAL to send a request to subscribe a service from Server S on the Internet. Included in the request, the device A also sends an ID and listener information. The request ID identifies the requested event type and the listener information tells the server S where to send notifications. An example of the ID is an integer. An example of the listener information is the IP address of device A and port number pair. Before establishing a connection to the server S, the server's identity is verified using the SAL.
Step 2: Server S sends a subscription reply to Device A in the same SAL, indicating whether the subscription is successful. If it is, the server S records the ID and the listener information in its database 306 if any of them are not yet there. Upon receiving a failed reply, Device A may choose to log the information, prompt user actions, or retry the subscription. If the subscription is successful, Device A is not required to do anything.
Step 3: At a later time, when an event corresponding to the request ID occurs on Server S, for each and every listener that has successfully subscribed to the event, the server S establishes a SAL to the listener using the listener's address and sends the notification through the link. The server S also includes the corresponding ID in the notification. In this process, the Device A and the server S mutually verify each other's identity. After the notification arrives, Device A processes it.

### Scheme 2, Embodiment 2

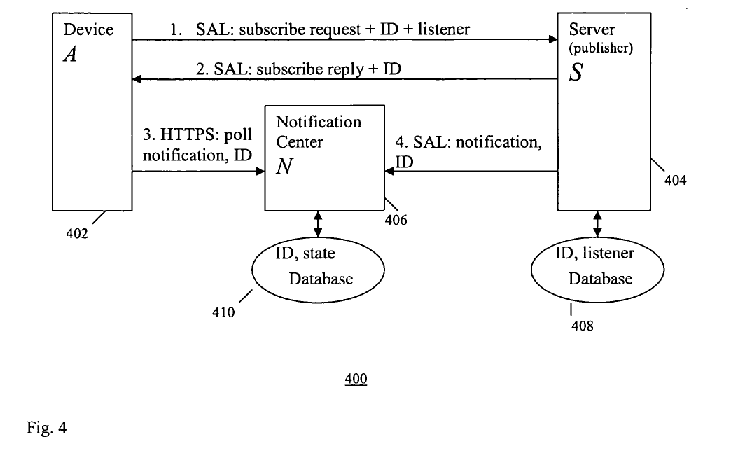

As shown in the example system 400 in FIG. 4, in the simplest case, this scheme involves a device A (402), a notification center N (406) which is a server specifically designed to serve notification forwarding, and a server S (404) which may be remotely linked through the Internet. This scheme includes the following steps 1-4 shown in FIG. 4:
Step 1: Device A uses a SAL to send a request to subscribe a service from Server S on the Internet. Included in the request, the device also sends an ID and listener information. The request ID identifies the requested event type and the listener information tells the server S where to send notifications. An example of the ID is an integer. An example of the listener information is the IP address and port number of the notification center N. Before establishing a connection to the server S, the server's identity is verified using the SAL.
Step 2: Server S sends a subscription reply to Device A in the same SAL, indicating whether the subscription is successful. If it is, the server S records the ID and the listener information in its database if any of them are not yet there.
Step 3: Upon receiving a failed reply, Device A may choose to log the information, prompt user actions, or retry the subscription. If the reply indicates a successful subscription, Device A starts to poll notifications identified by the ID from the notification center N.
Step 4: At a later time, when an event corresponding to the request ID occurs on Server S, for each and every listener that has successfully subscribed to the event, the server S establishes a SAL to the listener (i.e., the notification center N) using the address of the listener. In this processes the server S and the listener mutually verify each other's identity. Server S sends the notification plus the associated ID via established SAL link. Upon receiving the notification, the notification center N changes the state corresponding to the ID to indicate that new notification has arrived. When Device A polls next time, it will receive and process the notification.

### Scheme 3

This scheme uses a SAL for authentication, and uses challenge/response scheme for sender identity verification during notification over an ISL. For example, the verification can be done by the sender first asking permission to send a notification. In response, the receiver sends a challenge to the sender, where the challenge can be a random string generated at the time on the receiver. The sender then responds by computing and sending a hash using the random string, the user name, password supplied during a subscribing process. The receiver can then verify the sender's identity by computing the same hash using the random string and its saved user name and password.

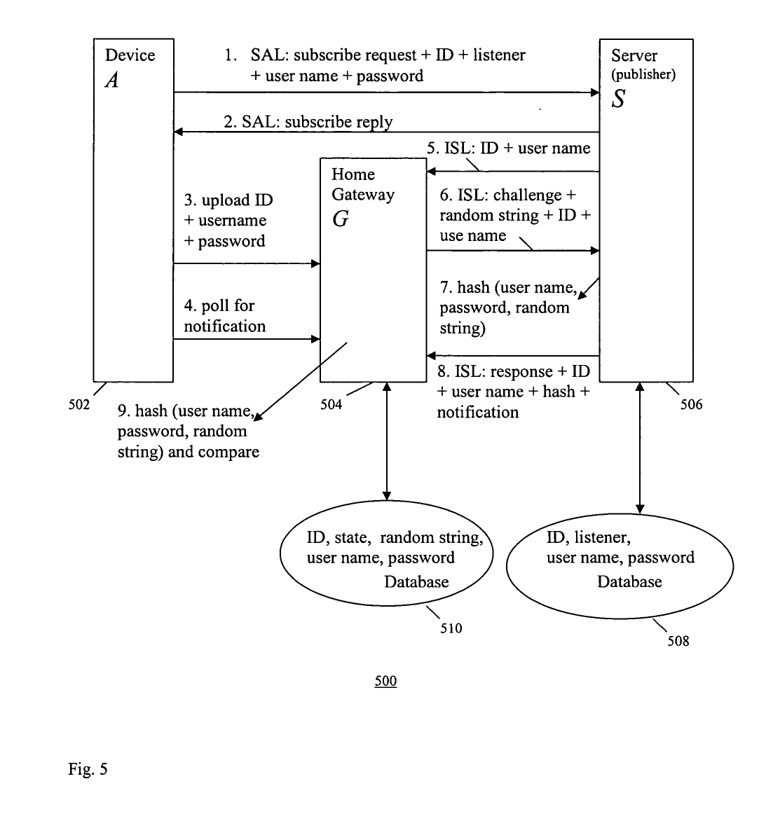

As shown by example system 500 in FIG. 5, in the simplest case, the embodiment involves a home with a device A (502) a home gateway G (504) which serves Device A, and a server S (506) which may be remotely linked through the Internet. This scheme includes the following steps 1-9 shown in FIG. 5:
Step 1: Device A uses a SAL, to send a request to subscribe a service from Server S on the Internet. Included in the request, the device A sends a request ID, listener information, a user name and a password, where either or both of the user name and password can be generated by a machine or supplied by a user. The request ID identifies the type of the requested event, and the listener information tells the server S where to send notifications. An example of the request ID and the subscriber ID are integers, and an example of listener information is the IP address and a port number of the home gateway G. Before establishing a connection to the server S, the server's identity is verified using the SAL.
Step 2: Server S sends a subscription reply to Device A in the same SAL, indicating whether the subscription is successful. If it is, the server S stores the ID, listener, the user name, and the password in a data storage indicated as the database 508 linked to Server S, if any of them are not yet there.
Step 3: Upon receiving a subscription failed reply, Device A may choose to log the information, prompt user actions, or retry the subscription. If the reply indicates a success, Device A uploads the request ID, the user name, and the password to Gateway G using a SAL. The gateway G then records the information in the data storage which is indicated as the database 510 linked to the gateway G, if any of them are not yet there.
Step 4: Device A starts to poll the gateway G for subscribed notifications.
Step 5: At a later time, when an event corresponding to the request ID occurs on Server S, for each and every listener that has successfully subscribed to the event, the server S establish an ISL connection, such as TCP, using the listener information. The server S then uses the connection to request permission to send a notification to the gateway G. The request includes the ID and the user name of the subscriber.
Step 6: Upon receiving the request for notification permission, Gateway G generates a random string and sends a challenge message back to Server S via an ISL. The message also passes back the ID and the user name originally sent with the request. The gateway G then records the random string in a database entry corresponding to the ID and the user name.
Step 7: When Server S receives the challenge, it fetches the password corresponding to the ID and the user name and computes a hash using the user name, the password, and the random string.
Step 8: Server S sends a response to the gateway G via an ISL. The response also includes the ID, the user name, the hash, and the notification.
Step 9: Upon receiving the notification, Gateway G uses the ID and the user name to fetch the password and the random string from the its database and computes a hash using the same hash function used by Server S with the user name, password, and the random string as arguments. It then compares the hash just computed and the hash passed in the message. If they are different, it discards the notification. Otherwise, it updates the state corresponding to the ID to indicate that a new notification has been received. When the device A polls afterwards, it will get and process the notification. A variation of this embodiment is for Device A starts polling for the notifications soon after it receives a response of successful subscription.

### Scheme 4

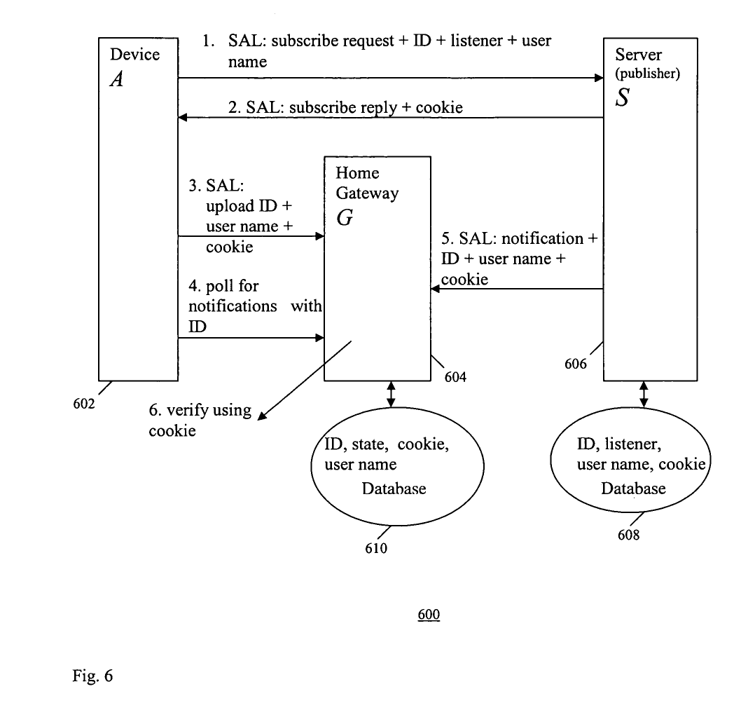

This scheme uses a SAL for both subscription and notification. It uses a cookie generated at subscription time to verify notification sender's identity at a later time. As shown by the example system 600 in FIG. 6, in the simplest case, the embodiment involves a home with a device A (602), a home gateway G (604) which serves Device A, and a server S (606) which may be remotely linked through the Internet. This scheme includes the following steps 1-6 shown in FIG. 6:
Step 1: Device A uses a SAL to send a request to subscribe a service from Server S on the Internet. Included in the request, the device A also sends a request ID, listener information, a user name, where the user name can be generated by a machine or supplied by a user. The request ID identifies the requested event type, and the listener information tells the server S where to send notifications. An example of the request ID is an integer, and an example of listener information is the IP address and a port number of the home gateway G. Before establishing a connection to the server S, the server's identity is verified using the SAL.
Step 2: Server S sends a subscription reply to Device A in the same SAL, indicating whether the subscription process is successful. The reply also includes a cookie generated by the server S. If the subscription is successful, the server S stores the ID, listener, the user name, and the cookie in a data storage indicated as the database 608 linked to it, if any of them are not yet there.
Step 3: If the subscription failed, Device A may choose to log the information, prompt user actions, or retry the subscription. Otherwise, Device A uploads the request ID, the user name, and the cookie to Gateway G using a SAL, which in turn records the information in the data storage which is indicated as the database 610 linked to the gateway G, if any of them are not yet there.
Step 4: Device A starts to poll for notification identified by the ID.
Step 5: At a later time, when an event corresponding to the request ID occurs on Server S, for each and every listener that has successfully subscribed to the event, the server S establishes a SAL connection using the listener information. The server S then uses the connection to send a notification to the gateway G. The notification message also includes the ID, the user name of the subscriber, and the cookie.
Step 6: Upon receiving the notification, Gateway G uses the ID and the user name to fetch the cookie from its database and compares the cookie with the cookie passed in the message. If they are different, gateway G discards the notification. Otherwise, gateway G updates the state corresponding to ID to indicate that a new notification for this type of events has been received. When the device polls afterwards, it will get and process the notification.

### Scheme 5

This scheme (message signing) uses a SAL for subscription. A notification is signed by the sender using its private key. The signed notification is sent using indirect link, such as email or direct link, such as HTTP. The receiver verifies the signature using the sender's public key which can be obtained from a trusted CA (Certification Authority), such as Verisign. In the rest of this section, email is used to explain the scheme. If HTTP is used, replacing the word email by the word HTTP would be sufficient to explain the alternative embodiment to one or ordinary skill in the art.

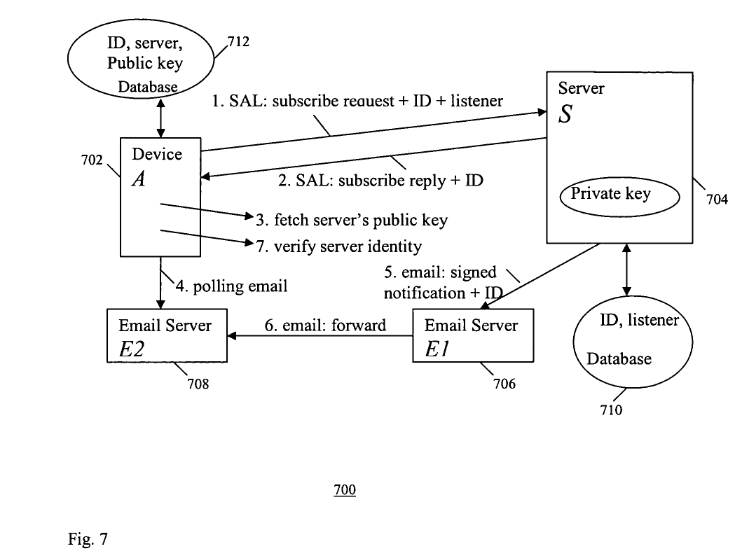

As shown by example system 700 in FIG. 7 below, in the simplest case, this embodiment involves a home with a device A (702), a server S (704) which may be remotely linked through the Internet, a first email server El (706) which may be linked to Server S via either a LAN or the Internet, and a second email server E2 (708) which may be linked to Device A via either a LAN or the Internet. Either or both of the email servers can belong to any service providers, enterprise, or homes. This embodiment includes the following steps 1-7 shown in FIG. 7:
Step 1: Device A uses a SAL to send a request to subscribe a service from Server S on the Internet. Included in the request, the device A also sends a request ID and listener information. The request ID identifies the requested event type and the listener information tells the server S where to send notifications. An example of the request ID is an integer, and an example of listener information is the email address of Device A whose email is served by the email server E2.
Step 2: Server S sends a subscription reply to Device A in the same SAL, indicating whether the subscription process is successful. If it is, the server S stores the ID and listener in a data storage indicated as the database 710 linked to it, if any of them are not yet there.
Step 3: Upon receiving a failed subscription, Device A may choose to log the information, prompt user actions, or retry the subscription. If the subscription is successful, Device A fetches the public key of the server S from a trusted CA and stores the request ID, server ID, and the public key in a data storage which is indicated as the database 712 linked to the device A where server ID is known to Device A since it initiated the subscription.
Step 4: Device A starts to poll the email server E2 for notification.
Step 5: At a later time, when an event corresponding to the request ID occurs on Server S, the server S generates and signs a notification using its private key. For each and every listener that has subscribed to the event, the server S sends the signed notification along with the corresponding ID via email using the email address of the listener.
Step 6: The email server E1 forwards the email to the email server E2, possibly through zero or more routers in the Internet.
Step 7: Upon receiving the email through polling in Step 4, Device A fetches the public key associated with the ID and the server information, and uses the key to verify the signature of the server S. If the verification is successful, the device processes the notification. Otherwise, it discards the notification.

As such, the present invention provides an effective authentication method and system for asynchronous eventing over the Internet. This system and method enhances authentication aspect of the security in Internet eventing that involves CE devices. Compared with prior art, authentication schemes according to the present invention are suited to CE devices that require low cost, that can be behind firewalls, and that can roam from one location to another possibly cross network domains. Further, the authentication schemes according to the present invention do not require key distributions among CE devices. Since securely distributing keys is a difficult problem, the present invention provides high security for eventing over the Internet. Further, the authentication schemes according to the present invention do not require communicating CE devices to have certificates. Since requiring all communicating CE devices to have their own certificates will at least slow down the acceptance by device manufacturers as well as consumers, the present invention has is more desirable the marketing place.

While the present invention has been described herein by example using the terminology of client-server, as those skilled in the art will recognize, the present invention is equally applicable in client-server, peer-to-peer, and other architectures. As such, the term “client” as used herein, can be replaced by “a first entity”, “event receiver”, “event destination”, “first node”, etc. Similarly, the term “server” as used herein, can be replaced by “a second entity”, “event sender”, “event source”, “second node”, etc. As such, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method for authenticating eventing between a first node and a second node in a network, comprising the steps of:
in a subscription phase, the first node sending a subscription request to the second node to express interest in receiving notifications associated with one or more particular events that may asynchronously occur on the second node;
the first node authenticating the second node by checking the identity of the second node, and if the first node determines that the second node can be trusted, the first node subscribes events from the second node, otherwise, the first node does not subscribe;
after a successful subscription, in a notification phase, the second node notifying each first node that has subscribed for a particular type of event; and
each first node upon receiving a notification, authenticating the second node by verifying that the received notification is sent by the second node with which the first node subscribed for the notification.

2. The method of claim 1 wherein the network includes the Internet.

3. The method of claim 1 wherein the first node comprises a CE device.

4. The method of claim 1 wherein the second node comprises a CE device.

5. The method of claim 1 wherein the first node and the second node utilize secure communication links.

6. The method of claim 1 wherein the first node and the second node utilize a communication link through which communicating parties can securely verify the identity of each other.

7. The method of claim 6 wherein the first node and the second node utilize Source Authenticate-able Links (SAL) for eventing communications.

8. The method of claim 1 wherein the first node and the second node utilize InSecure Links (ISL) for eventing communications.

9. The method of claim 1 wherein the first node and the second node utilize Source Authenticate-able Links for subscription phase communications, and InSecure Links for notification phase communications.

10. The method of claim 9 wherein upon receiving a notification, the first node uses the domain name included in a Web page pointed to by an HTTPS URL link embedded in a notification email from the second node verify the identity of the second node.

11. The method of claim 1 wherein the first node and the second node utilize Source Authenticate-able Links (SAL) for subscription phase and notification phase communications

12. The method of claim 11 wherein upon receiving a notification from a second node, the first node verifies identity of that second node using the SAL.

13. The method of claim 1 wherein Source Authenticate-able Links protocol is utilized for authentication, and ISL is used for sending notifications.

14. The method of claim 13 wherein the first node and second node use challenge/response protocol for verification of second node identity during the notification phase.

15. The method of claim 1 wherein the first node and second node use Source Authenticate-able Links (SAL) communication protocol for both subscription and notification.

16. The method of claim 15 wherein a cookie, generated during the subscription phase, is used during the notification phase for verification of the identity of the second node.

17. The method of claim 1 wherein the first node and the second node use Source Authenticate-able Links (SAL) communication protocol during the subscription phase, and during the notification phase a notification is signed by the second node using a private key, wherein the notification is sent to the first node by ISL, wherein the first node verifies the signature using the second node's public key.

18. An authenticating eventing system, comprising: a first node and a second node, wherein in a subscription phase, the first node sends a subscription request to the second node to express interest in receiving notifications associated with one or more particular events that may asynchronously occur on the second node; the first node authenticates the second node by checking the identity of the second node, and if the first node6 determines that the second node can be trusted, the first node subscribes notifications, otherwise, the first node does not subscribe; after a successful subscription, in a notification phase, the second node notifies each first node that has subscribed for a particular type of event; and each first node upon receiving a notification, authenticates the second node by verifying that the received notification is sent by the second node with which the first node subscribed for the notification.

19. The system of claim 18, wherein the network includes multiple first nodes, such that: in the subscription phase each first node sends a subscription request to the second node to express interest in receiving notifications associated with particular events that may asynchronously occur on the second node; and in the notification phase, after successful subscription, the second node notifies each first node that has subscribed for a particular type of event.

20. The system of claim 18, wherein the network includes multiple servers, such that: in the subscription phase the first node sends a subscription request to each second node to express interest in receiving notifications associated with particular events that may asynchronously occur on that second node; and in the notification phase, after successful subscription, each second node notifies each first node that has subscribed for a particular type of event.

21. The system of claim 18, wherein when an asynchronous event occurs, the second node publishes the event and sending a notification directly to the first node.

22. The system of claim 18, wherein when an asynchronous event occurs, the first node polls for notifications directly from the second node.

23. The system of claim 18, wherein when an asynchronous event occurs, the second node publishes the event on a notification center in the network, wherein the notification center sends a notification to the first node.

24. The system of claim 18, wherein when an asynchronous event occurs, the second node publishes the event on a notification center in the network, wherein the first node polls the notification center for the notification.

25. The system of claim 18, wherein the network further includes a notification center, such that: in the subscription phase the first node sends a subscription request to the notification center to request notifications for one or more events from one or more second nodes; and in the notification phase, after a successful subscription, the first node polls the notification center for notification.

26. The system of claim 25 wherein further each second node sends a subscription request to the notification center for permission to publish events on the notification center; after a successful server subscription, the second node publishes events on the notification center as they occur on the server; and the notification center notifies each first node of published notifications that the first node subscribed for with the notification center.

27. The system of claim 18 where the network includes a local area network (LAN) such that the first node and the second node are connected to the LAN.

28. The system of claim 18 where the network includes the Internet a local area network (LAN) such that the first node and the second node are connected to the Internet.

29. The system of claim 18 wherein the first node comprises a CE device.

30. The system of claim 1 wherein the second node comprises a CE device.
